(19) United States
(12) Patent Application Publication
(10) Pub. No.: US 2025/0015608 A1
(43) Pub. Date: Jan. 9, 2025

(54) ENERGY STORAGE APPARATUS, AND METHOD OF CONTROLLING ENERGY STORAGE APPARATUS

(71) Applicant: GS Yuasa International Ltd., Kyoto-shi, Kyoto (JP)

(72) Inventors: Akihito UMEDA, Kyoto-shi, Kyoto (JP); Yuki IMANAKA, Kyoto-shi, Kyoto (JP)

(21) Appl. No.: 18/570,941

(22) PCT Filed: Apr. 27, 2022
(86) PCT No.: PCT/JP2022/019021

§ 371 Date: Jun. 17, 2024

(30) Foreign Application Priority Data
Jun. 16, 2021 (JP) 2021-099969

(51) Int. Cl. H02J 7/00; H01M 10/42; H01M 10/44; H01M 10/48

(52) U.S. Cl. CPC H02J 7/0016; H01M 10/425; H01M 10/441; H01M 10/482; H02J 7/0048; H01M 2010/4271

(57) ABSTRACT

An energy storage apparatus 1 that is connected to a vehicle 2 includes: a plurality of energy storage cells 30A; a balancer circuit 38 that makes each of the plurality of energy storage cells 30A individually discharge electricity; a voltage sensor 35 that detects a voltage of each of the energy storage cells 30A; and a management unit 37. The management unit 37 performs: request processing (S103) where the management unit 37 requests the vehicle 2 to charge the energy storage apparatus 1 with electricity when a predetermined condition for reducing a difference in electric amount between the energy storage cells 30A is satisfied; and reducing processing (S106) where, after the energy storage apparatus 1 is charged with electricity by the vehicle 2, a voltage of each of the energy storage cells 30A is detected by the voltage sensor 35, and an operation time of the balancer circuit 38 is changed corresponding to a difference between detected voltages so as to reduce a difference in amount of electricity between the energy storage cells 30A.

### CROSS REFERENCE TO RELATED APPLICATIONS

This application is a National Stage Application, filed under 35 U.S.C. § 371, of International Application No. PCT/JP2022/019021, filed Apr. 27, 2022, which international application claims priority to and the benefit of Japanese Application No. 2021-099969, filed Jun. 16, 2021; the contents of both of which are hereby incorporated by reference in their entirety.

### BACKGROUND

### Technical Field

The present invention relates to an energy storage apparatus, and a method of controlling an energy storage apparatus.

### Description of Related Art

When an energy storage apparatus that includes energy storage cells is left without being used for a long period of time, a difference in amount of electricity [Ah] between the energy storage cells is increased due to a difference in amount of self-discharge electricity [Ah] between the energy storage cells. In view of such a circumstance, conventionally, a method has been carried out where voltages [V] of respective energy storage cell are detected when an energy storage apparatus is charged with electricity, and a balancer circuit is operated corresponding to detected voltages so that a difference in amount of electricity between the energy storage cells is reduced (see, for example, patent document JP-A-2009-71936 (paragraph: 0026)). Specifically, patent document 1 describes a method where a cell balance at the time of charging electricity is equalized by a voltage equalization circuit that equalizes voltages of cells that form an assembled battery.

### BRIEF SUMMARY

Conventionally, an energy storage apparatus mounted on a vehicle is charged with electricity supplied from a vehicle generator (a so-called alternator). When an energy storage apparatus is used in a high state of charge, regenerative charging of a vehicle cannot be received and hence, fuel efficiency is deteriorated. Accordingly, in recent years, a state of charge (SOC) is often suppressed to a value around 70% in order to leave room for reception of a regenerative current. A vehicle periodically charges an energy storage apparatus with electricity to a high SOC. However, there is a tendency that a time interval of charging electricity is becoming longer such as one week.

There is a case where a vehicle is parked for a long period such as one to two months. A vehicle generator is not operated during a period of time that a vehicle is parked. Accordingly, when a vehicle is parked for a long period of time, a time interval for charging an energy storage apparatus with electricity until an SOC becomes high is increased.

Conventionally, the study has not sufficiently made with respect to a problem that arises due to an increase in a time interval during which a charging device such as a vehicle generator charges an energy storage apparatus with electricity until an SOC becomes high.

The present disclosure discloses a technique capable of suppressing the use of an energy storage apparatus in a state where irregularity in amount of electricity between energy storage cells is held large.

According to one aspect of the present invention, there is provided an energy storage apparatus that is connected to a charging device, wherein the energy storage apparatus includes: a plurality of energy storage cells; a balancer circuit that makes each of the plurality of energy storage cells individually discharge electricity; a voltage sensor that detects a voltage of each of the energy storage cells; and a management unit. The management unit performs: request processing where the management unit requests the charging device to charge the energy storage apparatus with electricity when a predetermined condition for reducing a difference in electric amount between the energy storage cells is satisfied; and reducing processing where, after the energy storage apparatus is charged with electricity by the charging device, a voltage of each of the energy storage cells is detected by the voltage sensor, and an operation time of the balancer circuit is changed corresponding to a difference between detected voltages so as to reduce a difference in amount of electricity between the energy storage cells.

With such a configuration, it is possible to suppress the use of the energy storage apparatus in a state where irregularity in amount of electricity between energy storage cells is held large.

### BRIEF DESCRIPTION OF THE FIGURES

FIG. 1 is a schematic view of a vehicle and an energy storage apparatus according to an embodiment 1.

FIG. 2 is a schematic view of a power supply system of the vehicle.

FIG. 3 is an exploded perspective view of an energy storage apparatus.

FIG. 4A is a plan view of an energy storage cell.

FIG. 4B is a cross-sectional view taken along a line A-A illustrated in FIG. 4A.

FIG. 5 is a block diagram illustrating an electrical configuration of the energy storage apparatus.

FIG. 6 is a graph illustrating a change in current and a changed in voltage when the energy storage apparatus is fully charged with electricity by CC-CV charging.

FIG. 7 is a graph for explaining the reduction of a difference in remaining amount of electricity between energy storage cells.

FIG. 8 is a graph illustrating a change in QF with the lapse of time.

FIG. 9 is a flowchart of processing for reducing a difference in remaining amount of electricity between energy storage cells based on QF.

FIG. 10 is a graph illustrating an example of a plateau region.

FIG. 11 is a graph illustrating a change in voltage with the lapse of time when two energy storage cells each having a plateau region are charged with electricity.

FIG. 12A is a graph illustrating a change in voltage when the energy storage apparatus is fully charged with electricity (when a difference in amount of electricity between the energy storage cells is 50 mAh).

FIG. 12B is a graph illustrating a change in voltage when the energy storage apparatus is fully charged with electricity (when a difference in amount of electricity between the energy storage cells is 200 mAh).

### DETAILED DESCRIPTION OF VARIOUS EMBODIMENTS

### (Overall Configuration of Embodiment of Present Disclosure)

(1) An energy storage apparatus that is connected to a charging device includes: a plurality of energy storage cells; a balancer circuit that makes each of the plurality of energy storage cells individually discharge electricity; a voltage sensor that detects a voltage of each of the energy storage cells; and a management unit. The management unit performs:
request processing where the management unit requests the charging device to charge the energy storage apparatus with electricity when a predetermined condition for reducing a difference in electric amount between the energy storage cells is satisfied; and reducing processing where, after the energy storage apparatus is charged with electricity by the charging device, a voltage of each of the energy storage cells is detected by the voltage sensor, and an operation time of the balancer circuit is changed corresponding to a difference between detected voltages so as to reduce a difference in amount of electricity between the energy storage cells.

The above-described “charging device” can also be referred to as a “host device”. Alternatively, the “charging device” can also be referred to as a “charging control device”.

The “amount of electricity” may be a remaining amount of electricity of the energy storage cell. Alternatively, in a case where a difference between a full charging amount of electricity (in other words, a remaining amount of electricity at the time of full charging) of the energy storage cell and a present remaining amount of electricity of the energy storage cell is defined as a remaining chargeable amount of electricity of the energy storage cell, the “amount of electricity” may be a remaining rechargeable amount of electricity of the energy storage cell.

The reduction of a difference in a remaining amount of electricity may be referred to as “bottom alignment”, and the reduction of a difference in a remaining chargeable amount of electricity may be referred to as “top alignment”. For example, in a case where there is a difference in full charging amount of electricity between the energy storage cells or in a case where a difference in amount of electricity is reduced in a high state of charge (SOC), the difference in amount of electricity may be reduced by “top alignment”, and in a case where there is no difference in full charging amount of electricity between the energy storage cells or in a case where a difference in amount of electricity is reduced in a low SOC, a difference in amount of electricity may be reduced by “bottom alignment”.

A relatively accurate correlation exists between a voltage and an amount of electricity of the energy storage cell. Accordingly, conventionally, a method has been adopted where a difference in amount of electricity between the energy storage cells is reduced by estimating an amount of electricity from a voltage of an energy storage cell and by operating a balancer circuit corresponding to the estimated amount of electricity.

However, there are some energy storage cells that cannot accurately estimate an amount of electricity when a voltage is low. When the energy storage cell is charged with electricity, a voltage is increased. In view of such a circumstance, in a conventional energy storage apparatus that includes such energy storage cells, a method has been performed where voltages of respective energy storage cells are detected when an energy storage apparatus is charged with electricity by a charging device, and a balancer circuit is operated corresponding to the detected voltages so that a difference in amount of electricity between the energy storage cells is reduced.

As a result of intensive studies, the inventors of the present application have found that, with respect to an energy storage apparatus that includes energy storage cells where an amount of electricity cannot be accurately estimated when a voltage is low, such an energy storage apparatus has the following problems when a time interval during which a charging device charges electricity to the energy storage apparatus is long.

When the time interval during which the charging device charges electricity to the energy storage apparatus is long, a difference in amount of electricity between the energy storage cells is increased due to a difference in self-discharge amount of electricity between the respective energy storage cells during the time interval. Accordingly, there is a possibility that the energy storage apparatus is used in a state where a difference in amount of electricity between the energy storage cells is held large. When the energy storage apparatus is used in a state where a difference in amount of electricity between the energy storage cells is held large, the energy storage apparatus cannot exhibit its original performance at an early point of time by being affected by the energy storage cell having the smallest amount of electricity.

According to the energy storage apparatus described above, when a predetermined condition for reducing a difference in an amount of electricity between the energy storage cells is satisfied, the energy storage apparatus requests a charging device to charge electricity to the energy storage apparatus. Accordingly, compared with a case where the charging device charges the energy storage apparatus with electricity only periodically, the opportunities that the energy storage apparatus is charged with electricity can be increased. Therefore, according to the energy storage apparatus described above, with respect to an energy storage apparatus that includes energy storage cells where an amount of electricity cannot be accurately estimated when a voltage is low, it is possible to suppress the use of the energy storage apparatus in a state where a difference in amount of electricity between the energy storage cells is held large.

(2) In a case where the management unit is not capable of estimating a difference in amount of electricity between the energy storage cells from a difference between voltages detected by the voltage sensor, the management unit may shorten a time until the predetermined condition is satisfied next time compared with a case where the difference can be estimated.

When the difference in amount of electricity between the energy storage cells cannot be estimated from the difference between voltages detected by the voltage sensor, there is a possibility that the difference in amount of electricity between the energy storage cells cannot be sufficiently reduced even when an operation time of the balancer circuit is changed corresponding to the difference between the detected voltages. When the difference in amount of electricity between the energy storage cells cannot be sufficiently reduced, the energy storage apparatus is used in a state where the difference in amount of electricity between the energy storage cells is held large.

According to the energy storage apparatus described previously, when the difference in amount of electricity between the energy storage cells cannot be estimated from the difference in voltages detected by the voltage sensor, a time period until the next-time predetermined condition is satisfied is shortened compared with the case where the difference in amount of electricity between the energy storage cells can be estimated. Accordingly, it is possible to suppress the use of the energy storage apparatus in a state where the difference in amount of electricity between the energy storage cells is held large.

(3) The energy storage cell may have a plateau region where a change in voltage with respect to a change in a state of charge of the energy storage cell is small. In a case where the voltage of any one of the energy storage cells after the energy storage apparatus is charged with electricity is equal to or below an upper limit voltage in the plateau region, the management unit may shorten a time until the predetermined condition is satisfied next time compared with a case where the voltages of all of the energy storage cells are higher than the upper limit voltage in the plateau region.

As illustrated in FIG. 10, among the energy storage cells, there are some energy storage cells each having a plateau region where a change in an open circuit voltage (OCV) of the energy storage cell with respect to a change in a state of charge (SOC) is small. The plateau region is, more specifically, for example, a region where a change amount of OCV with respect to a change amount of SOC is equal to or less than 2 [mV/%]. In FIG. 10, a voltage Vp is an upper limit voltage in the plateau region. In the energy storage cell having the plateau region, in a state where the voltage is in the plateau region, even when the SOC is greatly changed, a change in voltage is small, and hence, an amount of electricity cannot be accurately estimated from the voltage. Accordingly, conventionally, in an energy storage apparatus that includes energy storage cells each having a plateau region, voltages are detected when the energy storage apparatus is charged, and the difference in amount of electricity between the energy storage cells is reduced.

The inventors of the present application have found that an energy storage apparatus that includes energy storage cells each having a plateau region has the following problems when a time interval of charging the energy storage apparatus 1 with electricity is long.

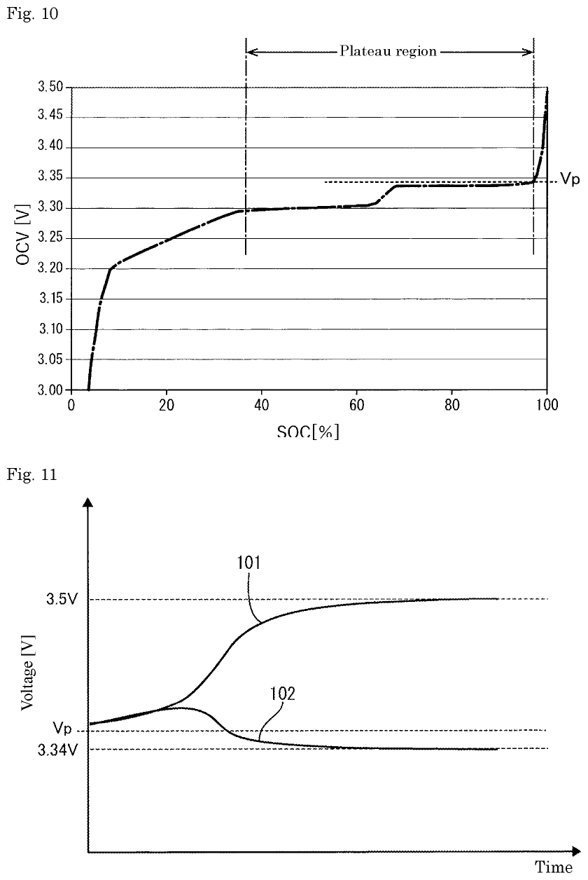

FIG. 11 is a graph illustrating an example of a change in voltage with the lapse of time when two energy storage cells each having a plateau region are charged with electricity. In FIG. 11, a solid line 101 indicates a change in voltage of the energy storage cell having a relatively high voltage, and a solid line 102 indicates a change in voltage of the energy storage cell having a relatively low voltage. As illustrated in FIG. 11, when the difference in voltage (in other words, the difference in amount of electricity) between the energy storage cells is large, there may be a case where, even when the energy storage apparatus is charged with electricity, the voltage of any one of the energy storage cells does not become higher than the upper limit voltage Vp in the plateau region. In other words, there may be a case where, the voltage of any one of the energy storage cells is equal to or below the upper limit voltage Vp in the plateau region. In a case where the voltage is equal to or below the upper limit voltage Vp in the plateau region, an amount of electricity of the energy storage cell cannot be accurately estimated from the voltage. Accordingly, even when the balancer circuit is operated, the difference in amount of electricity between the energy storage cells cannot be sufficiently reduced.

Even when the difference in amount of electricity between the energy storage cells cannot be sufficiently reduced by operating the balancer circuit only one time, the difference in amount of electricity is reduced as the time elapses by repeating the operation of the balancer circuit. However, recently, there is a tendency that a time interval that the charging device charges electricity to the energy storage apparatus become long. Accordingly, the balancer circuit is not operated at a short time interval and hence, there is a possibility that the energy storage apparatus is used in a state where the difference in amount of electricity between the energy storage cells is held large.

According to the energy storage apparatus described previously, in a case where the voltage of any one of the energy storage cells after the energy storage apparatus is charged with electricity is equal to or below the upper limit voltage Vp in the plateau region, compared to a case where the voltages of all energy storage cells are larger than the upper limit voltage Vp, time until the predetermined condition is satisfied next time is shortened and hence, the time until an operation of the balancer circuit is performed next time is shortened. Accordingly, it is possible to suppress the use of the energy storage apparatus in a state where the difference in amount of electricity between the energy storage cells is held large.

(4) The management unit performs: addition processing where a first predetermined value is added to a correlation value that correlates with a degree of irregularity in amount of electricity between the energy storage cells corresponding to the lapse of time; and a subtraction processing where a second predetermined value is subtracted from the correlation value after the reducing processing is performed, the predetermined condition is a condition that the correlation value has reached a predetermined threshold, and the management unit, in the subtraction processing, may make the second predetermined value small in a case where the voltage of any one of the energy storage cells after the energy storage apparatus is charged with electricity is equal to or below the upper limit voltage in the plateau region compared to the case where the voltages of all energy storage cells are higher than the upper limit voltage in the plateau region.

The above-mentioned “correlation value” may be, for example, a value that expresses a present degree of irregularity by % in a case where a degree of irregularity in amount of electricity between the energy storage cells at a certain point of time as 100%, or an estimated value of an absolute value that expresses a degree of irregularity in amount of electricity between the energy storage cells (for example, standard deviation, dispersion, or the difference in amount of electricity between the energy storage cells). Alternatively, the correlation value may be an elapsed time counted from a point of time that the balancer circuit is operated previous time.

The above-mentioned “first predetermined value” may take a positive value or a negative value. The addition of a negative value may be also referred to as the subtraction of a positive value. That is, the correlation value may have the positive correlation with the degree of irregularity in amount of electricity, or may have the negative correlation with the degree of irregularity in amount of electricity. In other words, the correlation value may be a so-called up counter or may be a down counter. When the first predetermined value takes a positive value, the second predetermined value also takes a positive value. When the first predetermined value takes a negative value, the second predetermined value also takes a negative value. The subtraction of the negative value may be also referred to as the addition of the positive value.

According to the energy storage apparatus described above, in a case where a voltage of any one of energy storage cells after the energy storage apparatus is charged with electricity is equal to or below upper limit voltage in the plateau region, the second predetermined value is made small compared to the case where the voltages of all energy storage cells are higher than the upper limit voltage in the plateau region and hence, time until the predetermined condition is satisfied next time is shortened.

(5) The above-mentioned management unit may perform a control such that, the larger the difference in voltages between the energy storage cells after the energy storage apparatus is charged, the time until the above-mentioned predetermined condition is satisfied next time may be shortened.

The above-mentioned “difference in voltage between energy storage cells” refers to a difference between the voltage of the energy storage cell having the highest voltage and the voltage of the energy storage cell having the lowest voltage.

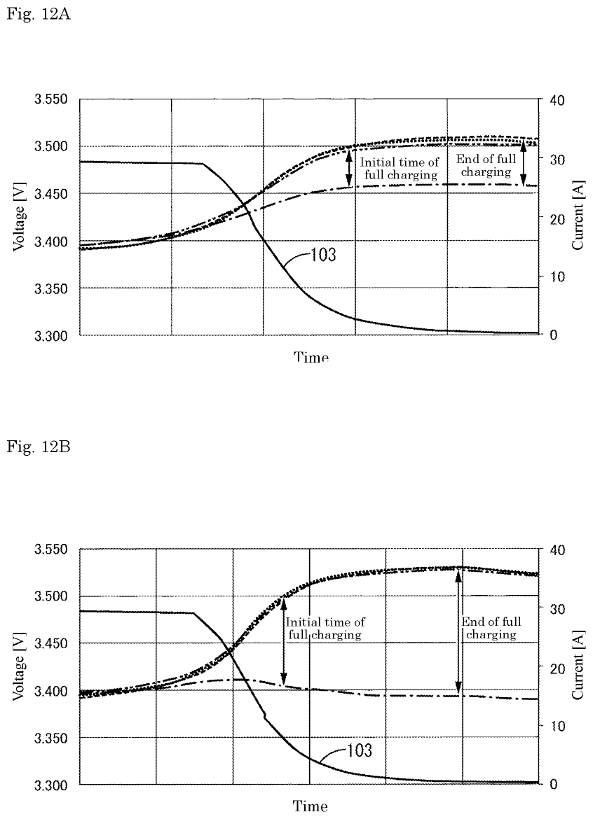

FIG. 12A and FIG. 12B illustrate one example of a change in voltage with time when four energy storage cells are charged with electricity. In FIG. 12A and FIG. 12B, a solid line 103 indicates a graph of a charging current, and other lines indicate graphs of voltages of respective energy storage cells. FIG. 12A illustrates a case where the difference in amount of electricity between the energy storage cells is 50 mAh, and FIG. 12B illustrates a case where the difference in amount of electricity between the energy storage cells is 200 mAh.

For example, in a case where an operation of the balancer circuit performed previous time is an operation after the balancer circuit is operated many times after a vehicle (charging device) is parked for a long period of time, as illustrated in FIG. 12A, the difference in voltage between the energy storage cells after charging electricity becomes relatively small. To the contrarily, in a case where the operation of the balancer circuit in the previous time is a first operation of the balancer circuit after the vehicle is parked for a long period of time, there is a possibility that the difference in voltage between the energy storage cells is not sufficiently reduced by operation of the balancer circuit at the previous time. In this case, as illustrated in FIG. 12B, the difference in voltage between the energy storage cells after being charged with electricity becomes relatively large.

The inventors of the present application have found that when the difference in voltage between the energy storage cells after the energy storage apparatus is charged with electricity is large, the estimation accuracy of the difference in amount of electricity between the energy storage cells is lowered compared with the case where the difference in voltage between the energy storage cells is small. Specifically, as illustrated in FIG. 12A, when the difference in voltage after being charged is small, the difference in voltage is substantially constant from an initial stage of charging electricity to an end stage of charging electricity. Accordingly, the difference in amount of electricity can be detected with a certain degree of accuracy from a voltage after charging. On the other hand, as illustrated in FIG. 12B, in a case where the difference in voltage after being charged with electricity is large, the difference in voltage changes between a voltage at an initial stage of charging and a voltage at the end stage of charging. Accordingly, even when an attempt is made so as to estimate the difference in amount of electricity from the difference in voltage, it is not possible to uniquely determine the difference in amount of electricity and hence, the difference in the estimated amount of electricity has a certain degree of error. Therefore, even when the balancer circuit is operated, there is a possibility that the difference in amount of electricity between the energy storage cells cannot be sufficiently reduced.

According to the energy storage apparatus described previously, the larger the difference in voltage between the energy storage cells after being charged with electricity, the shorter the time until the predetermined condition is satisfied next time is made. Accordingly, in a case where the difference in voltage is large, the time until the balancer circuit is operated next time can be shortened compared to the case where the difference in voltage is small. Accordingly, it is possible to suppress the use of the energy storage apparatus in a state where the difference in amount of electricity between the energy storage cells is held large.

(6) The management unit performs: addition processing where a first predetermined value is added to a correlation value that correlates with a degree of irregularity in amount of electricity between the energy storage cells corresponding to the lapse of time; and subtraction processing where a second predetermined value is subtracted from the correlation value after the reducing processing is performed, the predetermined condition is a condition that the correlation value has reached a predetermined threshold, and the management unit, in the subtraction processing, may make the second predetermined value smaller corresponding to the increase of the difference in voltage between the energy storage cells after the energy storage apparatus is charged with electricity.

According to the energy storage apparatus described previously, the larger the difference in voltage between the energy storage cells after the energy storage apparatus is charged with electricity, the smaller the second predetermined value is set. Accordingly, the larger the difference in voltage, the shorter the time until the predetermined condition is satisfied next time becomes shorter.

(7) The management unit, in the addition processing, may decide the first predetermined value corresponding to at least one of temperatures of the energy storage cells and a state of charge of the energy storage apparatus.

A change width per unit time of the degree of irregularity in amount of electricity between the energy storage cells differs depending on temperatures of the energy storage cells and a state of charge (SOC) of the energy storage apparatus. According to the energy storage apparatus described above, the first predetermined value is decided corresponding to at least one of the temperatures of the energy storage cells or the SOC of the energy storage apparatus. Accordingly, the degree of irregularity in amount of electricity between the actual energy storage cells is accurately reflected on the correlation values. Accordingly, it is possible to more appropriately determine whether or not the difference in amount of electricity between the energy storage cells should be reduced.

### DETAIL OF EMBODIMENT OF PRESENT DISCLOSURE

Hereinafter, embodiments of the present disclosure will be described. The present disclosure is not limited to these examples, it is intended that the present invention includes all modifications that are indicated in the scope of claims and fall within the meaning and scope equivalent to the claims.

The embodiments of the invention disclosed in the present specification can be implemented in various modes such as an apparatus, a method, a computer program for implementing the functions of the apparatus or the method, and a recording medium recording the computer program.

### Embodiment 1

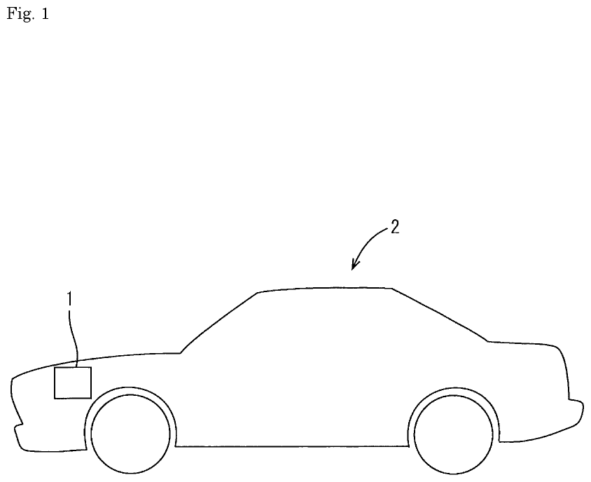

An embodiment 1 will be described with reference to FIG. 1 to FIG. 9. In the description made hereinafter, there may be a case where reference numerals used in the drawings are omitted with respect to the same constituent elements except for some constituent elements.

### (1) Energy Storage Apparatus

As illustrated in FIG. 1, an energy storage apparatus 1 according to the embodiment 1 is mounted on a vehicle 2 (an example of a charging device) such as an automobile.

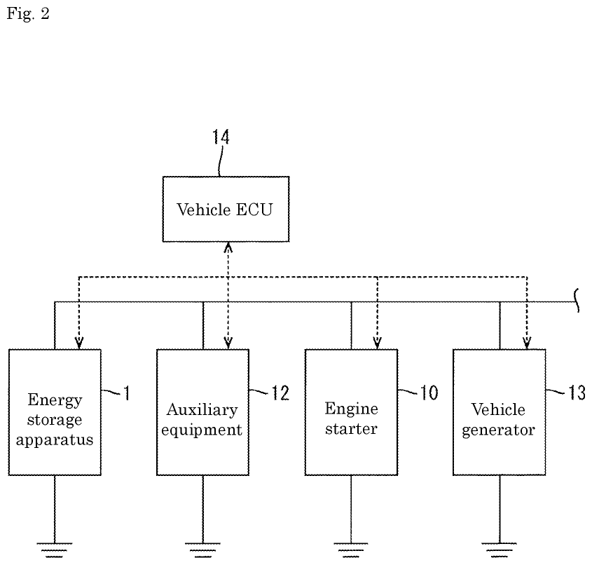

As illustrated in FIG. 2, the energy storage apparatus 1 supplies electricity to an engine starter 10 (a starter motor) and various auxiliary equipment 12 (an electrically operated power steering, a brake, a headlight, an air conditioner and the like) that the vehicle 2 includes. The energy storage apparatus 1 is charged with electricity generated by a vehicle generator 13 (an alternator). The energy storage apparatus 1 may be charged with electricity by the regenerative charging during braking.

The engine starter 10, the auxiliary equipment 12, the vehicle generator 13, and the energy storage apparatus 1 are communicably connected to a vehicle engine control unit (ECU) 14 via a communication cable.

### (2) Configuration of Energy Storage Apparatus

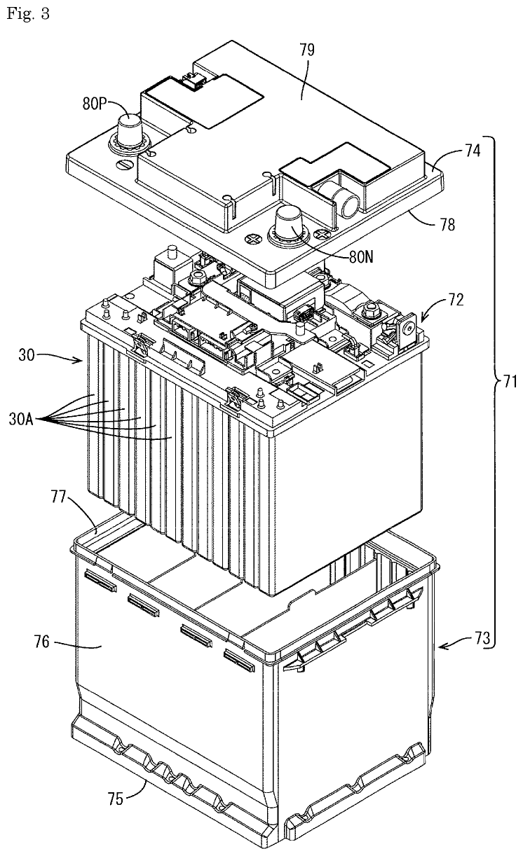

As illustrated in FIG. 3, the energy storage apparatus 1 includes a container 71. The container 71 includes a body 73 and a lid body 74 both made of a synthetic resin material. The body 73 has a bottomed cylindrical shape. The body 73 includes a bottom surface portion 75 and four side surface portions 76. An upper opening portion 77 is formed at an upper end portion of the body 73 by four side surface portions 76.

The container 71 houses an assembled battery 30 that includes a plurality of energy storage cells 30A and a circuit board unit 72. The energy storage cell 30A is a secondary battery that can be repeatedly charged and discharged. More specifically, the energy storage cell 30A is a lithium ion secondary battery. The circuit board unit 72 is disposed above the assembled battery 30.

The lid body 74 closes an upper opening portion 77 of the body 73. An outer peripheral wall 78 is formed on a periphery of the lid body 74. The lid body 74 has a protruding portion 79 having substantially a T-shape as viewed in a plan view. A positive external terminal 80P is fixed to one corner portion of a front portion of the lid body 74, and a negative external terminal 80N is fixed to the other corner portion of the front portion of the lid body 74.

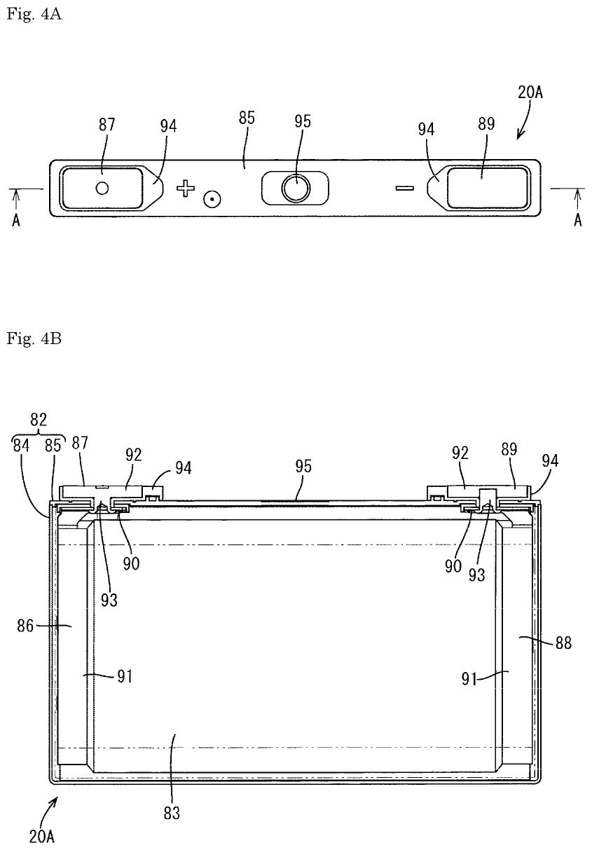

As illustrated in FIG. 4A and FIG. 4B, the energy storage cell 30A is configured such that an electrode assembly 83 is accommodated in a case 82 having a rectangular parallelepiped shape together with a nonaqueous electrolyte. The case 82 includes: a case body 84; and a lid 85 that closes an opening portion formed in an upper portion of the case body 84.

Although not illustrated in the drawings in detail, the electrode assembly 83 is formed such that a separator formed of a porous resin film is disposed between a negative electrode element that is formed by applying a negative active material to a base member formed of a copper foil and a positive electrode element that is formed by applying a positive active material to a base member formed of an aluminum foil. These elements all have a strip shape, and are wound in a flat shape so as to be accommodated in the case body 84 in a state where the position of the negative electrode element and the position of the positive electrode element are displaced toward opposite sides in the width direction with respect to the separator.

A positive electrode terminal 87 is connected to the positive electrode element via a positive electrode current collector 86, and a negative electrode terminal 89 is connected to the negative electrode element via a negative electrode current collector 88. The positive electrode current collector 86 and the negative electrode current collector 88 are each formed of a flat-plate-like pedestal portion 90 and a leg portion 91 extending from the pedestal portion 90. A through hole is formed in the pedestal portion 90. The leg portion 91 is connected to the positive electrode element or the negative electrode element. The positive electrode terminal 87 and the negative electrode terminal 89 each include: a terminal body portion 92; and a shaft portion 93 protruding downward from a center portion of a lower surface of the terminal body portion 92. In such a configuration, the terminal body portion 92 and the shaft portion 93 of the positive electrode terminal 87 are integrally formed with each other using aluminum (a single material). In the negative electrode terminal 89, the terminal body portion 92 is made of aluminum, and the shaft portion 93 is made of copper. The negative electrode terminal 89 is formed by assembling the terminal body portion 92 and the shaft portion 93 to each other. The terminal body portion 92 of the positive electrode terminal 87 and the terminal body portion 92 of the negative electrode terminal 89 are disposed at both end portions of the lid 85 via gaskets 94 made of an insulating material. The terminal body portion 92 of the positive electrode terminal 87 and the terminal body portion 92 of the negative electrode terminal 89 are exposed outward from the gaskets 94.

As illustrated in FIG. 4A, the lid 85 has a pressure release valve 95. The pressure release valve 95 is positioned between the positive electrode terminal 87 and the negative electrode terminal 89. The pressure release valve 95 is released when an internal pressure in the case 82 exceeds a limit value so as to lower the internal pressure in the case 82.

### (3) Electric Configuration of Energy Storage Apparatus

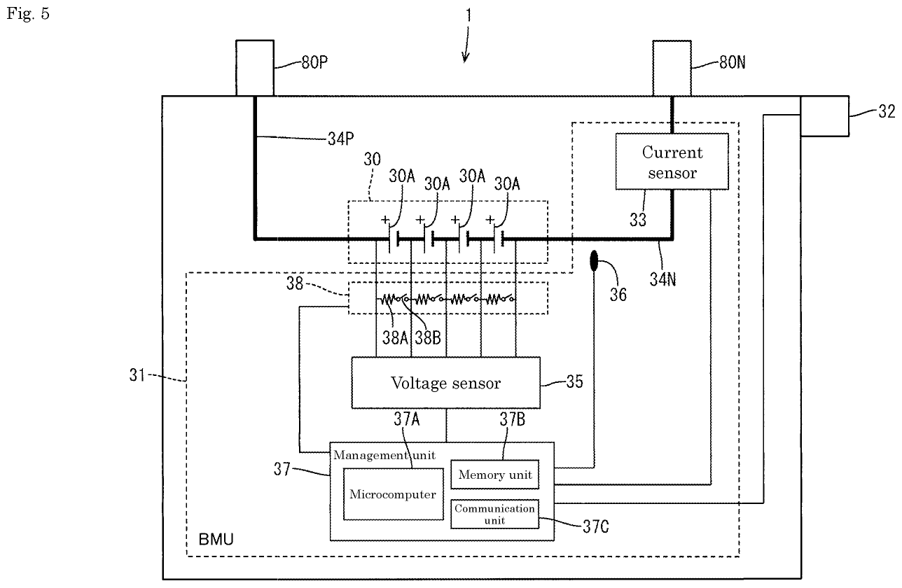

As illustrated in FIG. 5, the energy storage apparatus 1 includes the assembled battery 30, a BMU 31 (an example of a management device), and a communication connector 32.

The assembled battery 30 is connected to the positive external terminal 80P by a power line 34P, and is connected to the negative external terminal 80N by a power line 34N. The assembled battery 30 is formed by connecting twelve energy storage cells 30A to each other in three parallels and four series. For the sake of convenience, in FIG. 5, three energy storage cells 30A that are connected in parallel are indicated by one battery symbol. Specifically, the energy storage cell 30A is, for example, an LFP/Gr-based (so-called iron-based) lithium ion secondary battery in which a positive active material contains lithium iron phosphate (LiFePO4) and a negative active material contains graphite (Gr). The LFP/Gr-based (so-called iron-based) lithium ion secondary battery is an example of an energy storage cell having a plateau region.

The BMU 31 includes a current sensor 33, a voltage sensor 35, a temperature sensor 36, a balancer circuit 38, and a management unit 37.

The current sensor 33 is positioned on a negative electrode side of the assembled battery 30, and is disposed on the negative power line 34N. The current sensor 33 detects a charging/discharging current [A] of the assembled battery 30 and outputs the detected charging/discharging current [A] to the management unit 37.

The voltage sensor 35 is connected to both ends of each of the energy storage cells 30A by signal lines. The voltage sensor 35 detects battery voltages [V] of the respective energy storage cells 30A and outputs the detected battery voltages [V] to the management unit 37. A total voltage [V] of the assembled battery 30 is a sum of voltages of four energy storage cells 30A connected in series.

The temperature sensor 36 is a contact type sensor or a non-contact type sensor. The temperature sensor 36 detects temperatures [° C.] of the energy storage cells 30A, and outputs the detected temperatures to the management unit 37. Although not illustrated in FIG. 5, two or more temperature sensors 36 are provided. The respective temperature sensors 36 detect the respectively different temperatures of the energy storage cells 30A. The management unit 37 sets an average value of temperatures outputted from, for example, two or more temperature sensors 36 as the temperature of the energy storage apparatus 1.

The balancer circuit 38 is the passive balancer circuit 38 that reduces a difference in amount of electricity between the respective energy storage cells 30A by making the respective energy storage cells 30A individually discharge electricity. The balancer circuit 38 includes a discharge resistor 38A and a switch element 38B for each energy storage cell 30A. The discharge resistor 38A and the switch element 38B are connected in series, and are connected in parallel with the corresponding energy storage cell 30A. The switch element 38B is changed over between an electricity supply state and an electricity interruption state by the management unit 37. When the switch element 38B is brought into an electricity supply state, electricity is discharged from the energy storage cells 30A corresponding to the switch element 38B by the discharge resistor 38A.

The management unit 37 includes: a microcomputer 37A where a CPU, a RAM, and the like are integrated into one chip; a memory unit 37B; and a communication unit 37C. The microcomputer 37A manages the energy storage apparatus 1 by executing a management program stored in the memory unit 37B. The memory unit 37B is a storage medium capable of rewriting data, and stores a management program executed by the management unit 37 and various types of data to described later. The communication unit 37C is a circuit that allows the microcomputer 37A to communicate with the vehicle ECU 14.

The communication connector 32 is a connector to which a communication cable that allows the BMU 31 to communicate with the vehicle ECU 14 is connected.

### (4) Full Charging of Energy Storage Apparatus

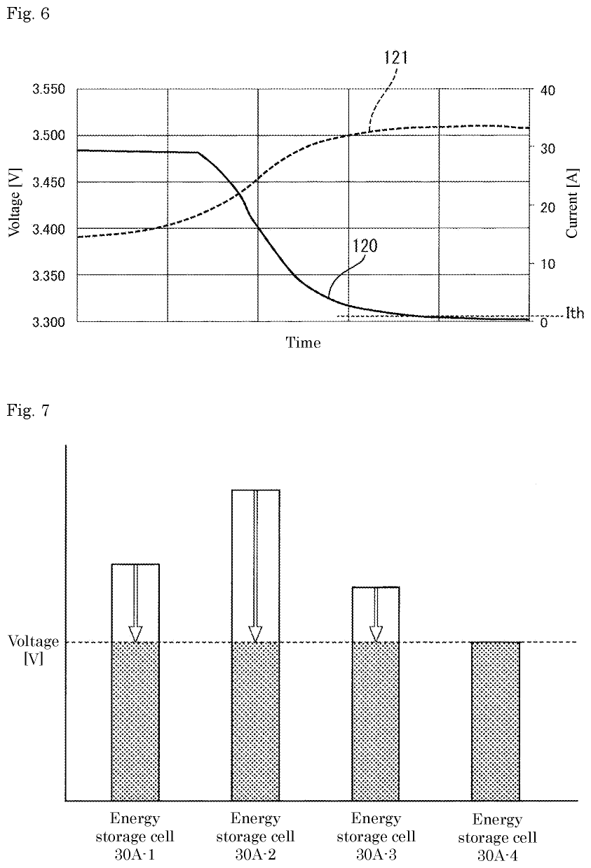

With reference to FIG. 6, full charging (an example of charging) of the energy storage apparatus 1 will be described. In this embodiment, constant current (CC)-constant voltage (CV) charging will be described as an example. In FIG. 6, a solid line 120 indicates a change in charging current, and a dotted line 121 indicates a change in voltage. In the CCCV charging, the energy storage apparatus 1 is charged at a constant current until the voltage of the energy storage cell 30A reaches a predetermined value. The CCCV charging is changed over to constant voltage charging when the voltage reaches a predetermined value. In the constant voltage charging, the current value is gradually reduced, and when the current value is reduced to a predetermined threshold Ith, the battery is fully charged.

The predetermined threshold Ith can be appropriately decided. For example, a current value when the SOC is 95% may be obtained in advance by an experiment, and the obtained current value may be used as the threshold Ith. In this case, the battery is fully charged when the SOC reaches 95%.

In the embodiment 1, the energy storage apparatus 1 is fully charged at the following three charging timings (charging timings A, B, C). The following three timings are examples of the timing of full charging. That is, the timing of full charging is not limited to the following three timings.

### Charging Timing A: Periodic Full Charging

The vehicle ECU 14 fully charges the energy storage apparatus 1 periodically such as every week (hereinafter, referred to as periodic full charging). In a case where the energy storage apparatus 1 is fully charged at the charging timing B or at the charging timing C described below, the energy storage apparatus 1 may be fully charged after the lapse of a fixed time from a point of time that the energy storage apparatus 1 is fully charged at the charging timing B or at the charging timing C instead of the lapse of a fixed time from the periodic full charging performed previous time.

### Charging Timing B: When Estimated Value of SOC is Reset at Full Charging

The management unit 37 estimates the SOC of the energy storage apparatus 1 by a current integration method. The current integration method is a method where a current value is detected at a predetermined time interval by the current sensor 33, and estimates an SOC by adding the detected current value to an initial value or by subtracting the detected current value from the initial value. In the current integration method, detection errors of the current sensor 33 are accumulated so that an estimated value of an SOC gradually becomes inaccurate. Accordingly, the management unit 37 resets the estimated value of SOC at full charging.

To be more specific, a relatively accurate correlation exists between an open circuit voltage (OCV) and an SOC of the energy storage apparatus 1. Accordingly, the management unit 37 updates the SOC estimated by the current integration method using the SOC estimated from the OCV. However, in the energy storage apparatus 1 having a plateau region, when a voltage is low, the SOC cannot be accurately estimated from the OCV. Accordingly, the management unit 37 requests the vehicle ECU 14 to perform full charging of energy storage apparatus 1 in a case where a predetermined condition for resetting the estimated value of the SOC is established, and detects the OCV by the voltage sensor 35 after the energy storage apparatus 1 is fully charged. The OCV is not limited to a voltage at which the circuit is completely opened, and may also be a voltage when a small current flows to an extent that the circuit is considered to be opened.

Charging timing C: When an index value (QF: Quality Factor) described later reaches 100% (an example of a predetermined threshold)

Although described in detail later, the management unit 37 determines whether or not a difference in remaining amount of electricity between the energy storage cells 30A is to be reduced based on an index value that correlates with the degree of irregularity in remaining amount of electricity between the energy storage cells 30A (hereinafter, referred to as QF). QF is an example of a correlation value. In a case where the management unit 37 determines that the difference in remaining amount of electricity is to be reduced, the management unit 37 requests the vehicle ECU 14 to perform full charging of the energy storage apparatus 1, and reduces the difference in remaining amount of electricity between the energy storage cells 30A by operating the balancer circuit 38 after the energy storage apparatus 1 is fully charged.

### (5) Operation of Balancer Circuit

The manner of operation for reducing the difference in remaining amount of electricity between the energy storage cells 30A by the balancer circuit 38 is described with reference to FIG. 7. In this embodiment, the description is made by taking the case where the difference in residual amount of electricity between the energy storage cells 30A is reduced as an example. For the sake of convenience, symbols 30A-1 to 30A-4 are given to four energy storage cells 30A.

When the energy storage apparatus 1 is fully charged with electricity, the management unit 37 detects voltages of the respective energy storage cells 30A by the voltage sensor 35, and estimates remaining amounts of electricity from the detected voltages. The management unit 37, using the energy storage cell 30A having the lowest voltage (the energy storage cell 30A-4 in this case) as a reference, decides discharge times (an example of operation times) based on differences between a remaining amount of electricity of the energy storage cell 30A-4 that is set as the reference and remaining amounts of electricity of other energy storage cells 30A with respect to other three energy storage cells 30A (the energy storage cells 30A-1, 30A-2, 30A-3 in this case). The management unit 37 operates the balancer circuit 38 for the discharge times decided for the respective other energy storage cells 30A thus reducing the difference in the remaining amount of electricity between the energy storage cells 30A.

The method for reducing a difference in remaining amount of electricity corresponding to a difference in detected voltage is not limited the above-mentioned method. For example, amounts of electricity to be discharged (or discharging times) may be decided in order in advance such that the amount of electricity of the energy storage cell 30A that has the largest remaining amount of electricity estimated from the detected voltage Is 18 mAh, the amount of electricity of the energy storage cell 30A that has the second largest remaining amount of electricity estimated from the detected voltage 1 s 12 mAh, and the amount of electricity of the energy storage cell 30A that has the third largest remaining amount of electricity estimated from the detected voltage 1 s 6 mAh.

The amounts of electricity (or discharge times) decided in advance corresponding to the order are also referred to as balance amounts. The management unit 37 may change the balance amount corresponding to a difference in detected voltage. For example, when the difference in voltage is small, the balance amount may be changed in order of 18 mAh, 12 mAh, 6 mAh, and when the difference in voltage is large, the balance amount may be changed in order of 24 mAh, 18 mAh, 6 mAh and the like.

### (6) Charging Timing C

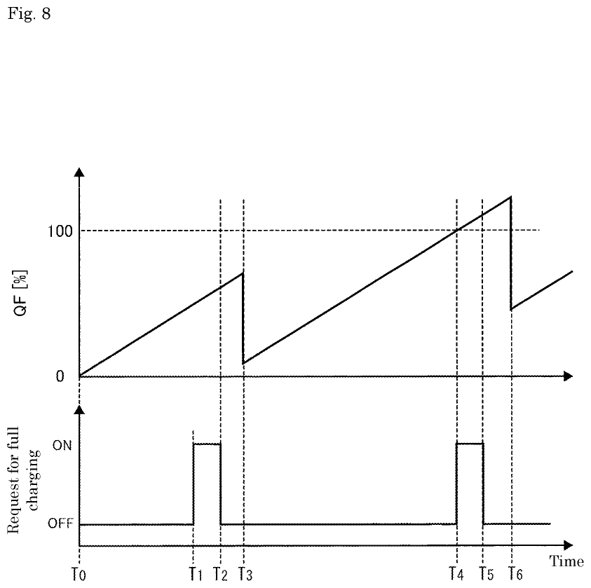

The charging timing C will be specifically described with reference to FIG. 8. As described previously, the management unit 37 decides the charging timing C on the basis of QF [%]. QF is defined as follows.

0%: A state where the degree of irregularity in the remaining amounts of electricity between the energy storage cells 30A is small so that it is unnecessary to reduce the difference in amounts of remaining electricity. Specifically, for example, a state where the difference between a remaining amount of electricity of the energy storage cell 30A having the largest voltage and a remaining amount of electricity of the energy storage cell 30A having the smallest voltage is 35 mAh or less.

100%: A state where the degree of irregularity in the remaining amount of electricity between the energy storage cells 30A is large so that the difference in the remaining amount of electricity should be reduced. Specifically, for example, a state where the difference between a remaining amount of electricity of the energy storage cell 30A having the largest voltage and a remaining amount of electricity of the energy storage cell 30A having the smallest voltage is 300 mAh or above.

The degree of irregularity in the remaining amount of electricity between the energy storage cells 30A is increased with the lapse of time. Accordingly, the management unit 37 adds a first predetermined value [%] to QF at constant intervals, and requests the vehicle ECU 14 to perform full charging when QF reaches 100%. The first predetermined value is a positive value. The state that the QF has reached 100% is an example of a predetermined condition for deceasing the difference in amount of electricity between the energy storage cells.

The first predetermined value is decided based on, for example, a time period from a point of time at which the energy storage apparatus 1 where the degree of irregularity in remaining amount of electricity between the energy storage cells 30A is 0% is left to a point of time that such degree of irregularity in remaining amount of electricity amount becomes 100%. This time period is decided in advance by an experiment. For example, it is assumed that the time until the degree of irregularity reaches 100% from 0% is 1000 hours. In this case, for example, if 0.1% is added to QF every 1 hour, QF becomes 100% after 1000 hours. Accordingly, for example, in a case where the first predetermined value is added every one hour, 0.1% is added as the first predetermined value, and in a case where the first predetermined value is added every two hours, 0.2% is added as the first predetermined value. Hours that define a time interval at which the first predetermined value is added is appropriately decided.

An example of a change of the QF with the lapse of time will be described with reference to FIG. 8. In the description made hereinafter, an action of operating the balancer circuit 38 is referred to as a balancer operation. In FIG. 8, a point of time TO is a point of time at which QF is 0%. A point of time T1 is a charging timing other than the charging timing C (that is, the charging timing A or B). The full charging of the energy storage apparatus 1 is started at the point of time T1. A point of time T2 is a point of time at which the full charging is completed.

When the full charging is completed, the management unit 37 starts a balancer operation. A point of time T3 is a point of time at which the balancer operation is completed. When the balancer circuit 38 is operated, the difference in remaining amount of electricity between the energy storage cells 30A (in other words, the degree of irregularity in remaining amount of electricity) becomes small. Accordingly, the management unit 37 subtracts a second predetermined value [%] from QF when the balancer operation is completed. The second predetermined value also takes a positive value. The second predetermined value will be described later.

A point of timing T4 is a timing at which QF reaches 100% (that is, charging timing C). When the QF reaches 100%, the management unit 37 requests the vehicle ECU 14 to fully charge the battery with electricity. A point of time T5 is a point of time at which the full charging is completed. When the full charging is completed, the management unit 37 starts a balancer operation. A point of time T6 is a point of time at which the balancer operation is completed. When the balancer operation is completed, the management unit 37 subtracts the second predetermined value from the QF.

### (7) Decide Second Predetermined Value

When the balancer circuit 38 is operated, the difference in remaining amount of electricity between the energy storage cells 30A becomes small. Accordingly, basically, the second predetermined value is decided to be the same value as the present QF. Therefore, QF after subtracting the second predetermined value becomes 0%. However, in a case (a) and a case (b) described hereinafter, there is a possibility that even when the balancer circuit 38 is operated, the difference in remaining amount of electricity is not be sufficiently reduced. Accordingly, in these cases, the management unit 37 makes the second predetermined value smaller than the present QF in order to shorten the time until the predetermined condition is satisfied next time (in other words, to shorten the time until the balancer circuit 38 is operated next time).

(a) Case where Difference in Voltage Between Energy Storage Cells is Large after Energy Storage Apparatus is Fully Charged

The management unit 37, after the energy storage apparatus 1 is fully charged (more specifically, after the energy storage apparatus 1 is fully charged and before the balancer circuit 38 is operated) reduces the second predetermined value as the difference in voltage between the energy storage cells 30A is increased. The second predetermined value that corresponds to the difference in voltage is decided in advance by an experiment, and is stored in the memory unit 37B. The management unit 37 decides the second predetermined value by reading the second predetermined value that corresponds to the difference in voltage from the memory unit 37B.

When the second predetermined value is reduced, the time until the QF reaches 100% next time is shortened. Accordingly, the time until the predetermined condition is satisfied next time is shortened compared with the case where the second predetermined value is not reduced (that is, the case where the difference in voltage between the energy storage cells 30A is small). In other words, the time until the balancer circuit 38 is operated next time is shortened.

(b) Case where Voltage of any One of Energy Storage Cells after Energy Storage Apparatus is Fully Charged with Electricity is Equal to or Below Upper Limit Voltage in Plateau Region

In a case where the voltage of any one of energy storage cells 30A after the energy storage apparatus 1 is fully charged with electricity (specifically, after the energy storage apparatus 1 is fully charged and before the balancer circuit 38 is operated) is equal to or below the upper limit voltage Vp in the plateau region, the management unit 37 makes the second predetermined value small compared to the case where the voltages of all energy storage cells 30A are higher than the upper limit voltage Vp in the plateau region.

Specifically, for example, when the voltage of any one of the energy storage cells 30A is equal to or below the upper limit voltage Vp in the plateau region, the management unit 37 decides the second predetermined value to a value close to 0% (for example, 0% to 5%). Accordingly, the QF is minimally reduced and hence, the time until the predetermined condition is satisfied next time becomes shorter compared with the case where the voltages of all energy storage cells 30A are higher than the upper limit voltage Vp in the plateau region.

### (8) Processing for Reducing Difference in Remaining Amount of Electricity Between Energy Storage Cells Based on QF

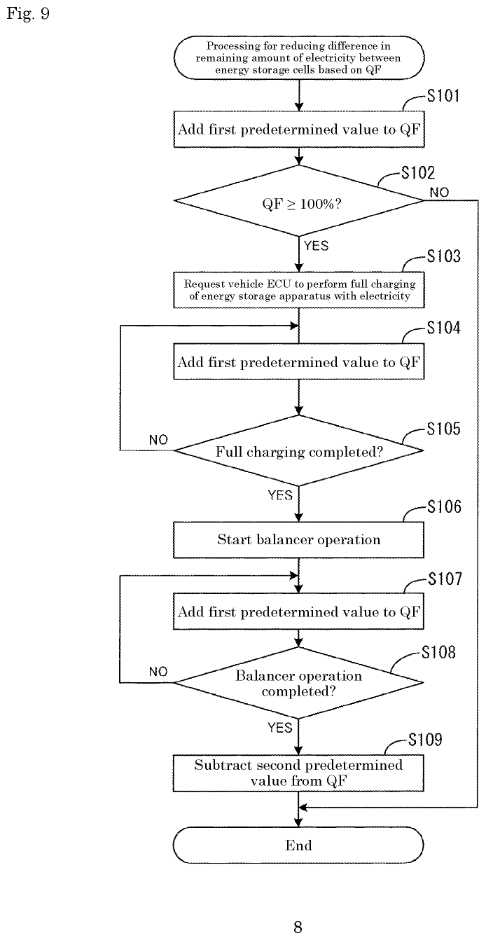

The flow of processing for reducing the difference in remaining amount of electricity between the energy storage cells 30A based on QF is described with reference to FIG. 9. This processing is repeatedly performed at predetermined time intervals.

In S101, the management unit 37 adds the first predetermined value to QF (an example of addition processing). It is assumed that the QF at a point of time that the use of the energy storage apparatus 1 is started is 0%.

In S102, the management unit 37 determines whether or not QF is 100% or more (that is, whether or not a predetermined condition for reducing the difference in remaining amount of electricity between the energy storage cells 30A is satisfied). The management unit 37 advances the processing to step S103 when QF is 100% or more, and finishes the processing when QF is less than 100%.

In S103, the management unit 37 requests the vehicle ECU 14 to fully charge the energy storage apparatus 1 with electricity (an example of request processing).

In S104, the management unit 37 adds the first predetermined value to QF.

In S105, the management unit 37 determines whether or not full charging is completed. The management unit 37 advances processing to S106 when full charging is completed, and returns the processing to S104 and repeats the processing when full charging is not completed.

In S106, the management unit 37 starts the balancer operation (an example of the reducing processing).

In S107, the management unit 37 adds the first predetermined value to QF.

In S108, the management unit 37 determines whether or not the balancer operation is completed. The management unit 37 advances processing to S109 when the balancer operation is completed, and returns the processing to S107 and repeats the processing when full charging is not completed.

In S109, the management unit 37 subtracts the second predetermined value from QF (an example of subtraction processing). As described previously, the second predetermined value is decided corresponding to the difference in voltage between the energy storage cells 30A after the energy storage apparatus 1 is fully charged. When the voltage of any one of the energy storage cells 30A is equal to or below the upper limit voltage Vp in the plateau region after full charging is performed, the management unit 37 decides the second predetermined value to a value close to 0%.

### (9) Advantageous Effects of Embodiment

According to the energy storage apparatus 1, the energy storage apparatus 1 requests the vehicle 2 to perform full charging of the energy storage apparatus with electricity when QF reaches 100%. Accordingly, the opportunity that the energy storage apparatus 1 is fully charged with electricity can be increased compared with the case where the full charging of the energy storage apparatus 1 is performed only at the charging timing A (or the case where the full charging is performed only at the charging timing A and at the charging timing B). Accordingly, in the energy storage apparatus 1, even in a case where the energy storage apparatus 1 is an energy storage apparatus that includes energy storage cells 30A where a remaining amount of electricity cannot be accurately estimated when the voltage is low, even when a time interval that the vehicle 2 fully charges the energy storage apparatus 1 with electricity is long, it is possible to suppress the use of the energy storage apparatus 1 in a state where a difference in remaining amount of electricity between the energy storage cells 30A is held large.

According to the energy storage apparatus 1, in the case where the difference in amount of electricity between the energy storage cells 30A cannot be estimated from the difference in voltage detected by the voltage sensor 35 (for example, in the case where the voltage of any one of the energy storage cells 30A is equal to or below the upper limit voltage Vp in the plateau region, or in the case where the difference in voltage between the energy storage cells 30A is large), the time until the predetermined condition is satisfied next time is shortened compared with the case where the difference in the amount of electricity between the energy storage cells 30A can be estimated (in the case where the voltage of any one of the energy storage cells 30A is larger than the upper limit voltage Vp in the plateau region or in the case where the difference in voltage between the energy storage cells 30A is small). Accordingly, it is possible to suppress the use of the energy storage apparatus 1 in a state where the difference in the amount of electricity between the energy storage cells 30A is held large.

According to the energy storage apparatus 1, in a case where the voltage of any one of the energy storage cells 30A after the energy storage apparatus 1 is fully charged with electricity is equal to or below the upper limit voltage Vp in the plateau region, compared to a case where the voltages of all energy storage cells 30A are larger than the upper limit voltage Vp, time until the predetermined condition is satisfied next time is shortened and hence, the time until the operation of the balancer circuit 38 is performed next time is shortened. Accordingly, it is possible to suppress the use of the energy storage apparatus 1 in a state where the difference in remaining amount of electricity between the energy storage cells 30A is held large.

According to the energy storage apparatus 1, in a case where a voltage of any one of energy storage cells 30A after the energy storage apparatus 1 is fully charged with electricity is equal to or below the upper limit voltage Vp in the plateau region, the second predetermined value is made small compared to the case where the voltages of all energy storage cells 30A are higher than the upper limit voltage Vp in the plateau region and hence, the time until QF becomes 100% next time is shortened. In other words, the time until the predetermined condition is satisfied next time is shortened. Accordingly, even in the case where the time interval at which the vehicle 2 fully charges the energy storage apparatus 1 is long, it is possible to suppress the use of the energy storage apparatus 1 in a state where the difference in remaining amount of electricity between the energy storage cells 30A is held large.

According to the energy storage apparatus described previously, the larger the difference in voltage between the energy storage cells 30A after the energy storage apparatus 1 is fully charged with electricity, the shorter the time until the predetermined condition is satisfied next time is set. Accordingly, it is possible to suppress the use of the energy storage apparatus 1 in a state where the difference in remaining amount of electricity between the energy storage cells 30A is held large.

According to the energy storage apparatus 1, the larger the difference in voltage between the energy storage cells 30A after the energy storage apparatus 1 is fully charged with electricity, the shorter the second predetermined value is set. Accordingly, compared to the case where the difference in voltage is small, the time until QF reaches 100% next time is shortened. In other words, the time until the predetermined condition is satisfied next time is shortened. Accordingly, it is possible to suppress the use of the energy storage apparatus 1 in a state where the difference in remaining amount of electricity between the energy storage cells 30A is held large.

### Embodiment 2

The embodiment 2 is a modification of the embodiment 1.

The degree of irregularity in the remaining amount of electricity between the energy storage cells 30A differs depending on temperatures of the energy storage cells 30A and the SOC of the energy storage apparatus 1. Accordingly, the management unit 37 according to the embodiment 2, when adding the first predetermined value to QF at constant time intervals, decides the first predetermined value corresponding to the temperatures of the energy storage cells 30A and the SOC of the energy storage apparatus 1. Specifically, the management unit 37, in the case where the temperatures of the energy storage cells 30A are high, increases the first predetermined value compared with the case where the temperatures of the energy storage cells 30A are low. Alternatively, the management unit 37, in the case where the SOC of the energy storage apparatus 1 is high, increases the first predetermined value compared with the case where the SOC of the energy storage apparatus 1 is low. How much the first predetermined value is increased corresponding to the temperatures of the energy storage cells 30A and the SOC of the energy storage apparatus 1 can be appropriately decided by an experiment or the like.

According to the energy storage apparatus 1 according to the embodiment 2, the first predetermined value is decided corresponding to at least one of the temperatures of the energy storage cells 30A or the SOC of the energy storage apparatus 1. Accordingly, the degree of irregularity in remaining amount of electricity between the actual energy storage cells 30A is accurately reflected on QF. Accordingly, it is possible to more appropriately determine whether or not the difference in remaining amount of electricity between the energy storage cells 30A should be reduced.

### OTHER EMBODIMENTS

The present invention is not limited to the embodiments described with reference to the above description and drawings. For example, the following embodiments are also included in the technical scope of the present invention.

(1) In the embodiment described above, the full charging has been described as an example of the charging. However, the charging is not limited to the full charging. For example, the charging may be charging up to a region where a difference in amount of electricity between the energy storage cells 30A can be detected. However, even if charging of electricity is performed up to the region, in a case where the voltage of any one of the energy storage cells 30A is equal to or below the upper limit voltage Vp in the plateau region or the difference in voltage between the energy storage cells 30A is large, there is a possibility that the difference in amount of electricity cannot be accurately detected.

(2) In the embodiment described above, the description has been made with respect to the case where the larger the difference in voltage between the energy storage cells 30A after full charging is performed, the shorter the second predetermined value is made and, further, the second predetermined value is set to a value close to 0% when the voltage of any one of the energy storage cells 30A is equal to or less than the upper limit voltage Vp in the plateau region as an example. In place of such a case, only the case may be adopted where the larger the difference in voltage between the energy storage cells 30A after full charging is performed, the smaller the second predetermined value is made. Alternatively, in place of such a case, only the case may be adopted where the second predetermined value is set to a value close to 0% when the voltage of any one of the energy storage cells 30A is equal to or less than the upper limit voltage Vp in the plateau region.

(3) In the embodiment described above, the description has been made with respect to the case where the remaining amount of electricity is adopted as an example of the amount of electricity of the energy storage apparatus 1. However, the amount of electricity of the energy storage apparatus 1 may be the remaining amount of chargeable electricity. In the embodiment described above, the description has been made with respect to the case where the difference in the remaining amount of electricity between the energy storage cells 30A is reduced by bottom alignment as an example. However, in the case where the amount of electricity of the energy storage apparatus 1 is the remaining chargeable amount of electricity, the difference in the amount of electricity may be reduced by top alignment.

(4) In the embodiment described above, the description has been made with respect to the case where QF is used as the correlation value. However, the correlation value is not limited to QF. For example, the correlation value may be an estimated value of an absolute value (for example, standard deviation or variance) that expresses the degree of irregularity in an amount of electricity between the energy storage cells 30A. Alternatively, the correlation value may be an elapsed time counted from a point of time that the energy storage apparatus 1 is fully charged with electricity previous time.

(5) In the embodiment described above, the description has been made with respect to the case where the passive type balancer circuit is used as an example of the balancer circuit 38. On the other hand, the balancer circuit 38 may be an active type balancer circuit that reduces a difference in remaining amount of electricity by enabling the energy storage cells 30A having a high voltage to charge electricity to the energy storage cells 30A having a low voltage.

(6) In the embodiment described above, the description has been made with respect to the case where the LFP/Gr-based (so-called iron-based) lithium ion secondary battery is used as an example of the energy storage cell 30A having a plateau region. However, the energy storage cell 30A having such a plateau region is not limited to the LFP/Gr-based lithium ion secondary battery.

(7) In the embodiment described above, the description has been made with respect to the case where the energy storage apparatus 1 is mounted on a vehicle (moving body) as an example. However, the energy storage apparatus 1 may be mounted on other moving bodies such as an aircraft and a ship. In such a case, an aircraft, a ship, or the like is an example of the charging device.

(8) In the embodiment described above, the case has been described where the lithium ion secondary battery has been used as an example of the energy storage cell 30A. However, the energy storage cell 30A may be a capacitor accompanied by an electrochemical reaction.

(9) The energy storage apparatus may be configured as follows.

An energy storage apparatus is connected to a charging device. The energy storage apparatus includes:
a plurality of energy storage cells;
a balancer circuit that individually discharges each of the energy storage cells; and
a voltage sensor that detects a voltage of each of the energy storage cells; and
a management unit.

### The Management Unit Performs:

request processing where the management unit requests the charging device to charge the energy storage apparatus with electricity when a predetermined condition for reducing a difference in electric amount between the energy storage cells is satisfied; and
reducing processing where, after the energy storage apparatus is charged with electricity by the charging device, a voltage of each of the energy storage cells is detected by the voltage sensor, and the balancer circuit is operated corresponding to a difference between detected voltages so as to reduce a difference in amount of electricity between the energy storage cells.

1. An energy storage apparatus connected to a charging device, the energy storage apparatus comprising:
a plurality of energy storage cells;
a balancer circuit that individually discharges each of the energy storage cells;
a voltage sensor that detects a voltage of each of the energy storage cells; and
a management unit,
wherein the management unit is configured to perform:
request processing where the management unit requests the charging device to charge the energy storage apparatus with electricity when a predetermined condition for reducing a difference in electric amount between the energy storage cells is satisfied; and
reducing processing where, after the energy storage apparatus is charged with electricity by the charging device, a voltage of each of the energy storage cells is detected by the voltage sensor, and an operation time of the balancer circuit is changed corresponding to a difference between detected voltages so as to reduce a difference in amount of electricity between the energy storage cells.

2. The energy storage apparatus according to claim 1, wherein
the management unit, in a case where the management unit is not capable of estimating a difference in amount of electricity between the energy storage cells from a difference between voltages detected by the voltage sensor, shortens a time until the predetermined condition is satisfied next time compared with a case where the management unit is capable of estimating the difference in amount of electricity between the energy storage cells.

3. The energy storage apparatus according to claim 2, wherein
the energy storage cell has a plateau region where a change in voltage with respect to a change in a state of charge of the energy storage cell is small, and
in a case where the voltage of any one of the energy storage cells after the energy storage apparatus is charged with electricity is equal to or below an upper limit voltage in the plateau region, the management unit is configured to shorten a time until the predetermined condition is satisfied next time compared with a case where the voltages of all of the energy storage cells are higher than the upper limit voltage in the plateau region.

4. The energy storage apparatus according to claim 3, wherein
the management unit is configured to perform:
addition processing where a first predetermined value is added to a correlation value that correlates with a degree of irregularity in amount of electricity between the energy storage cells corresponding to the lapse of time; and subtraction processing where a second predetermined value is subtracted from the correlation value after the reducing processing is performed,
the predetermined condition is a condition that the correlation value has reached a predetermined threshold, and
the management unit, in the subtraction processing, is configured to make the second predetermined value small in a case where the voltage of any one of the energy storage cells after the energy storage apparatus is charged with electricity is equal to or below an upper limit voltage of the plateau region compared to the case where the voltages of all of the energy storage cells are higher than the upper limit voltage in the plateau region.

5. The energy storage apparatus according to any one of claims 2 to 4, wherein
the management unit is configured to perform a control such that the larger the difference in voltages between the energy storage cells after the energy storage apparatus is charged with electricity, the shorter the time until the predetermined condition is satisfied next time is made.

6. The energy storage apparatus according to claim 5, wherein
the management unit is configured to perform: addition processing where a first predetermined value is added to a correlation value that correlates with a degree of irregularity in amount of electricity between the energy storage cells corresponding to the lapse of time; and subtraction processing where a second predetermined value is subtracted from the correlation value after the reducing processing is performed,
the predetermined condition is a condition that the correlation value has reached a predetermined threshold, and
the management unit, in the subtraction processing, is configured to make the second predetermined value smaller corresponding to the increase of the difference in voltage between the energy storage cells after the energy storage apparatus is charged with electricity.

7. The energy storage apparatus according to claim 4 or claim 6, wherein
the management unit, in the addition processing, is configured to decide the first predetermined value corresponding to at least one of temperatures of the energy storage cells and a state of charge of the energy storage apparatus.

8. A method of controlling an energy storage apparatus connected to a charging device, wherein the energy storage apparatus includes:
a plurality of energy storage cells;
a balancer circuit that makes each of the plurality of energy storage cells individually discharge electricity; and
a voltage sensor that detects a voltage of each of the energy storage cells,
the method of controlling an energy storage apparatus comprising:
request step of requesting the charging device to charge the energy storage apparatus with electricity when a predetermined condition for reducing a difference in electric amount between the energy storage cells is satisfied; and
reducing step where, after the energy storage apparatus is charged with electricity by the charging device, a voltage of each of the energy storage cells is detected by the voltage sensor, and an operation time of the balancer circuit is changed corresponding to a difference between detected voltages so as to reduce a difference in amount of electricity between the energy storage cells.
